(19) United States
(12) Patent Application Publication
(10) Pub. No.: US 2024/0400462 A1
(43) Pub. Date: Dec. 5, 2024

(54) SISIC COMPONENT AND PRODUCTION METHOD THEREOF

(71) Applicant: AGC Inc., Tokyo (JP)

(72) Inventors: Rui HAYASHI, Tokyo (JP); Shuhei OGAWA, Tokyo (JP); Koki TANAKA, Tokyo (JP); Hiroyuki YAMAMOTO, Tokyo (JP)

(73) Assignee: AGC Inc., Tokyo (JP)

(21) Appl. No.: 18/804,292

(22) Filed: Aug. 14, 2024

Related U.S. Application Data
(63) Continuation of application No. PCT/JP2023/005423, filed on Feb. 16, 2023.

(30) Foreign Application Priority Data
Feb. 18, 2022 (JP) 2022-024100
Oct. 11, 2022 (JP) 2022-162968

(51) Int. Cl. C04B 35/565; C04B 41/45; C04B 41/50; C04B 41/91

(52) U.S. Cl. CPC C04B 35/565; C04B 41/457; C04B 41/5096; C04B 41/91; C04B 2235/3826; C04B 2235/428; C04B 2235/728

(57) ABSTRACT

Provided is a conventionally unavailable, novel SiSiC component. The SiSiC component has at least one long hole formed therein, wherein the long hole has a diameter of 2 mm or smaller, wherein the long hole has a length of 100 mm or longer, and wherein the content of elemental Si is 10 to 60 vol %.

### TECHNICAL FIELD

The present invention relates to a SiSiC component and a production method thereof.

### BACKGROUND ART

Conventionally, there is known a SiSiC component as a composite material containing silicon carbide (SiC) and silicon (Si) (see Patent Document 1 listed below).

### PRIOR ART DOCUMENTS

### Patent Documents

Patent Document 1: WO2019/194137
Patent Document 2: WO2022/075290
Patent Document 3: WO2022/075288

### DISCLOSURE OF INVENTION

### Technical Problem

The SiSiC component is expected to be used for various applications because of its excellent properties such as thermal conductive property, and the development of a new SiSiC component is also desired.

For example, even if a long hole having an inner diameter of 2 mm or smaller and a length of 100 mm or longer is to be formed in the SiSiC component by machining with a drill, the SiSiC component is so hard that it is not possible to accomplish such machining due to bending or breaking of the drill. Even in the case of machining with a laser light, it is not possible to allow the laser light to reach a depth of 100 mm or longer while maintaining an inner diameter of 2 mm or smaller.

The present invention has been made in view of the foregoing. It is an object of the present invention to provide a conventionally unavailable, novel SiSiC component.

### Solution to Problem

As a result of intensive studies, the present inventors have found that the above object can be achieved by adoption of the following configurations, and thereby have accomplished the present invention.

That is, the present invention provides the following [1] to [15].
[1] A SiSiC component having at least one long hole formed therein, wherein the long hole has a diameter of 2 mm or smaller, wherein the long hole has a length of 100 mm or longer, and wherein the content of elemental Si in the SiSiC component is 10 to 60 vol %.
[2] The SiSiC component according to the above [1], which has a Young's modulus of 230 GPa or higher.
[3] The SiSiC component according to the above [1] or [2], which has an electrical resistivity of 0.0001 to 100 Ω·cm.
[4] The SiSiC component according to any one of the above [1] to [3], wherein the long hole is a non-through hole.
[5] The SiSiC component according to any one of the above [1] to [4], wherein an inner wall of the long hole has a surface roughness of 3.0 μm or greater.
[6] The SiSiC component according to any one of the above [1] to [5], wherein an axis deviation amount of the long hole is 0.80 mm or less.
[7] The SiSiC component according to any one of the above [1] to [6], wherein the hole shape of the long hole is a circular shape, a polygonal shape, or a combined shape thereof.
[8] The SiSiC component according to any one of the above [1] to [7], wherein the O content in an inner wall of the long hole is 1 atomic % or higher.
[9] A method of producing the SiSiC component as defined in any one of the above [1] to [8], comprising: preparing a SiC formed body; impregnating the SiC formed body with elemental Si; and forming a long hole in the obtained SiSiC component by electrical discharge machining.
[10] A method of producing a SiSiC component, comprising: preparing a SiC formed body; impregnating the SiC formed body with elemental Si; and performing electrical discharge machining on the obtained SiSiC component.
[11] The method of producing a SiSiC component according to the above [10], wherein occurrence of a burr on a surface of the SiSiC component is suppressed.
[12] The method of producing a SiSiC component according to the above [10], wherein adhesion of a deposit to a surface of the SiSiC component is suppressed.
[13] The method of producing a SiSiC component according to the above [10], comprising: preparing the SiC formed body; impregnating the SiC formed body with the elemental Si; and performing the electrical discharge machining on the obtained SiSiC component, whereby a deposit adhered to a surface of the SiSiC component is removed.
[14] The method of producing a SiSiC component according to the above [13], wherein the deposit contains Si eluted from the SiSiC component.
[15] The method of producing a SiSiC component according to the above [10], comprising: preparing the SiC formed body; impregnating the SiC formed body with the elemental Si; and performing the electrical discharge machining on the obtained SiSiC component, whereby a burr occurring on a surface of the SiSiC component is removed.

### Advantageous Effects of Invention

According to the present invention, there is provided a conventionally unavailable, novel SiSiC component.

### BRIEF DESCRIPTION OF DRAWINGS

FIG. 1 is a perspective view illustrating a SiSiC component.

FIG. 2 is a cross-sectional view taken along line A-A of FIG. 1.

FIG. 3 is a schematic view illustrating a long hole whose hole shape is a combined shape of circular shapes.

### DESCRIPTION OF EMBODIMENTS

The terms used in the present invention have the following meanings.

A numerical range expressed by using “to” means a range including numerical values described before and after “to” as the lower limit and the upper limit.

In numerical ranges stepwisely described in the present specification, the upper limit or the lower limit in a certain numerical range may be replaced by the upper limit or the lower limit in any of the other numerical ranges stepwisely described in the present specification. In numerical ranges described in the present specification, the upper limit or the lower limit in a certain numerical range may be replaced by a numerical value in Examples.

### [SiSiC Component]

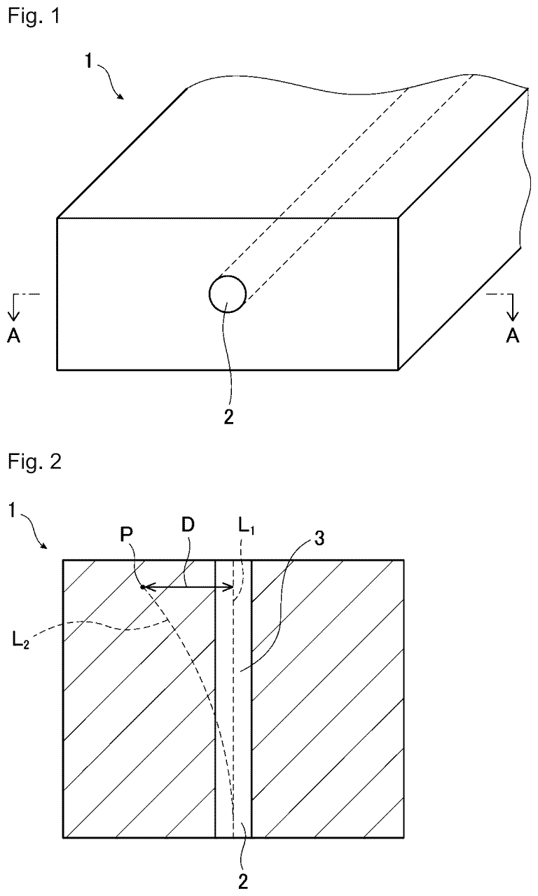

FIG. 1 is a perspective view illustrating a SiSiC component 1. FIG. 2 is a cross-sectional view taken along line A-A of FIG. 1. The SiSiC component 1 is a composite material containing silicon (Si) and silicon carbide (SiC) and is, for example, low in thermal expansion coefficient and excellent in heat resistance, wear resistance, thermal conductive property, strength and the like.

### <Long Hole>

The SiSiC component 1 has formed therein a long hole 2 which is long in one direction.

Although only one long hole 2 is shown in FIGS. 1 and 2, the SiSiC component 1 may have a plurality of long holes 2. In the case where there are the plurality of long holes 2, these long holes 2 may be parallel to each other or may intersect each other. The long hole 2 may be curved.

The long hole 2 may be a though hole penetrating the SiSiC component 1 (see FIG. 2) or may be a non-through hole having one end closed.

This long hole 2 is formed by the after-mentioned electrical discharge machining.

### «Hole Shape»

The hole shape of the long hole 2 shown in FIG. 1 is, but is not limited to, a perfect circular shape.

For example, the hole shape of the long hole 2 is suitably a circular shape, a polygonal shape, or a combined shape thereof.

The circular shape includes a perfect circular shape (see FIG. 1) and an elliptical shape.

The polygonal shape includes a triangular shape, a quadrilateral shape (such as a square shape, a rectangular shape and the like) and a pentagonal or higher polygonal shape.

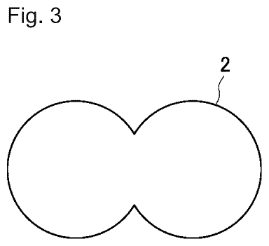

The combined shape means a combined shape of circular shapes (see FIG. 3 mentioned below) or a combined shape of a circular shape and a polygonal shape.

FIG. 3 is a schematic view illustrating the long hole 2 whose hole shape is a combined shape of circular shapes.

The hole shape of the long hole 2 shown in FIG. 3 is a shape in which two perfect circles partially overlap each other. The long hole 2 of this shape can be obtained by forming two holes of perfect circular hole shape such that these two holes partially overlap each other.

The hole shape of the long hole 2 refers to the shape of a cross section of the long hole 2 as taken perpendicular to the center line thereof.

### «Diameter»

The long hole 2 has a diameter of 2 mm or smaller. For increasing the thermal conductivity of the SiSiC component 1, the diameter of the long hole 2 is preferably 1.6 mm or smaller, more preferably 1.2 mm or smaller.

On the other hand, the lower limit of the diameter of the long hole 2 is not particularly limited.

However, machining of a hole with a small diameter tends to result in large deviations from the tolerances on dimensions such as a machining diameter and a machining area under the influence of cutting chips or vibrations during machining. These deviations can be improved to a certain degree by removing the cutting chips with discharge of a working fluid and by decreasing the machining speed. In the case where it is desired to maintain the machining speed suitable for production, the diameter of the long hole 2 is preferably 0.1 mm or larger, more preferably 0.2 mm or larger, still more preferably 0.5 mm or lager, from the viewpoint of the discharge efficiency of a working fluid in electrical discharge machining.

The diameter of the long hole 2 refers to the diameter of a cross section of the long hole 2 as taken perpendicular to the center line thereof. Herein, an average value obtained from any five cross sections is used. The diameter of the long hole 2 is determined using a micrograph of a cross section of the SiSiC component 1.

When the cross section of the long hole 2 has a circular shape or a quadrilateral shape, the minimum size (minimum length) of the circular shape or the quadrilateral shape is used as the diameter of the long hole 2. More specifically, in the case of a perfect circular shape, the diameter of the perfect circular shape is used. In the case of an elliptical shape, the length of a minor axis of the elliptical shape is used. In the case of a square shape, the length of one side of the square shape is used. In the case of a rectangular shape, the length of a short side of the rectangular shape is used. In the case of a triangular shape or a pentagonal or higher polygonal shape, the length of the shortest side of the triangular shape or the pentagonal or higher polygonal shape is used.

When the cross section of the long hole has a combined shape, the minimum size (minimum length) of respective shapes (circular shape or quadrilateral shape) constituting the combined shape is used.

### «Length»

The long hole 2 has a length of 100 mm or longer, preferably 120 mm or longer, more preferably 150 mm or longer.

On the other hand, the upper limit of the length of the long hole 2 is not particularly limited and is, for example, 450 mm, preferably 400 mm, more preferably 300 mm.

The length of the long hole 2 refers to the length of the center line of the long hole 2.

### «Axis Deviation Amount»

An axis deviation amount will be now explained below with reference to FIG. 2.

For example, assumed is the case where a linear long hole 2 is formed in the SiSiC component 1. In this case, the center line of the long hole 2 may become a warped center line L2, rather than the originally intended (linear) center line L1, during the process of forming the long hole 2. This is called “axis deviation”.

A point on the warped center line L2 located farthest from the originally intended center line L1 is defined as P. The minimum distance D from the point P to the center line L1 is determined as an axis deviation amount.

From the viewpoint of forming the long hole 2 as designed, it is preferable that the axis deviation amount is as small as possible. More specifically, the axis deviation amount is preferably 0.80 mm or less, more preferably 0.50 mm or less, still more preferably 0.30 mm or less.

The axis deviation amount can be reduced by forming the long hole 2 by the after-mentioned electrical discharge machining.

### «Surface Roughness of Inner Wall»

An inner wall 3 of the long hole 2 (a surface of the SiSiC component 1 defining the long hole 2) has a surface roughness (Ra) of preferably 3.0 μm or greater, more preferably 4.0 μm or greater, still more preferably 4.5 μm or greater, particularly preferably 5.0 μm or greater.

A foreign substance such as a resin may be adhered to the inner wall 3 of the long hole 2. In such a case, the inner wall 3 of the long hole 2 tends to be brought into point contact with the foreign substance as it is rough. The foreign substance, when once adhered to such a rough inner wall, is difficult to separate from the inner wall under the anchoring effect (in other words, the adhesion strength between the inner wall 3 of the long hole 2 and the foreign substance is high).

On the other hand, the upper limit of the surface roughness is not particularly limited. The surface roughness of the inner wall 3 of the long hole 2 is, for example, 10.0 μm or smaller, preferably 8.0 μm or smaller.

As a method for controlling the surface roughness of the inner wall 3 of the long hole 2 to the above range, for example, there may be mentioned a method of forming the long hole in the SiSiC component 1 by electrical discharge machining.

The surface roughness of the inner wall 3 of the long hole 2 is determined by the following procedure.

First, the SiSiC component 1 is subjected to cutting or grinding such that the long hole 2 is cut in half, thereby allowing a cross section of the SiSiC component 1 to be exposed (see FIG. 2). The exposed cross section is then observed with a laser microscope (vk-x200, manufactured by KEYENCE Corporation). By image processing of the observed micrograph, an arithmetic mean roughness Ra is obtained along the center line of the long hole 2. The thus-obtained roughness Ra is determined as the surface roughness of the inner wall 3 of the long hole 2.

### «O Content in Inner Wall»

Regarding the composition of the inner wall 3 of the long hole 2, the higher the content of oxygen (O) (hereinafter also referred to as O content), the higher the content of low-surface-energy SiO₂, and the less likely the occurrence of fouling on the inner wall 3 of the long hole 2.

For excellent fouling resistance of the inner wall 3 of the long hole 2, the O content in the inner wall 3 of the long hole 2 is preferably 1 atomic % or higher, more preferably 3 atomic % or higher, still more preferably 5 atomic % or higher, particularly preferably 7 atomic % or higher, most preferably 9 atomic % or higher.

On the other hand, the upper limit of the O content is not particularly limited. The O content in the inner wall 3 of the long hole 2 is, for example, 25 atomic % or lower, preferably 20 atomic % or lower.

As a method for controlling the O content in the inner wall 3 of the long hole 2 to the above range, for example, there may be mentioned a method of forming the long hole 2 in the SiSiC component 1 by electrical discharge machining. During the electrical discharge machining, the inner wall 3 of the long hole 2 being machined is oxidized whereby SiO₂ is formed.

The O content in the inner wall 3 of the long hole 2 is determined by the following procedure.

First, the SiSiC component 1 is subjected to cutting or grinding such that the long hole 2 is cut in half, thereby allowing a cross section of the SiSiC component 1 to be exposed (see FIG. 2). On the exposed cross section, oxygen (O) and constituent elements (Si, C and the like) of the SiSiC component 1 are quantified with an EDX (energy dispersive X-ray) analyzer attached to a scanning electron microscope (SEM). The O content (unit: atomic %) in the inner wall 3 of the long hole 2 is determined based on the quantification results.

### <Content of Elemental Si>

As will be described below, the SiSiC component 1 is required to adequately contain elemental Si.

More specifically, the content of elemental Si in the SiSiC component 1 is 10 vol % or higher, preferably 12 vol % or higher, more preferably 15 vol % or higher, for excellent strength properties.

On the other hand, if the content of elemental Si is too high, the SiSiC component 1 is lowered in Young's modulus and the like and becomes insufficient in strength.

Hence, the content of elemental Si in the SiSiC component 1 is 60 vol % or lower, preferably 45 vol % or lower, more preferably 35 vol % or lower, still more preferably 30 vol % or lower, particularly preferably 25 vol % or lower, for sufficient strength (Young's modulus).

The content (unit: vol %) of elemental Si is determined from an optical micrograph by the following procedure.

In a micrograph of a cross section of the SiSiC component 1, a gray zone corresponds to SiC; and a lighter and more whitish zone corresponds to elemental Si.

Using an image analysis software (WinROOF2015), the area ratios of SiC and elemental Si are obtained from a micrograph of any cross section of the SiSiC component 1. The obtained area ratios are used, as they are, as respective volume ratios.

An average value of volume ratios obtained at any five fields of view is used as the content of elemental Si.

### <Young's Modulus>

The Young's modulus of the SiSiC component 1 is preferably 230 GPa or higher, more preferably 250 GPa or higher, still more preferably 300 GPa or higher, particularly preferably 320 GPa or higher, most preferably 350 GPa or higher.

The Young's modulus of the SiSiC component 1 is a dynamic modulus measured at 20° C. by a testing method for elastic modulus (ultrasonic pulse method) described in JIS R1602:1995.

### <Electrical Resistivity>

As will be described below, the SiSiC component 1 has electrical conductivity by adequately containing elemental Si. More specifically, the electrical resistivity of the SiSiC component 1 is preferably 100 (=1×10²) Ω·cm or lower, more preferably 10 (=1×10¹) Ω·cm or lower, still more preferably 1 (=1×10⁰) Ω·cm or lower.

On the other hand, the lower limit of the electrical resistivity of the SiSiC component 1 is not particularly limited and is, for example, 0.0001 (=1×10⁻⁴) Ω·cm, preferably 0.001 (=1×10⁻³) Ω·cm.

The electrical resistivity of the SiSiC component 1 is measured according to a volume resistivity measurement method described in JIS C2141-1992.

### <Density>

The density of the SiSiC component 1 is preferably 2.00 g/cm³ or higher, more preferably 2.40 g/cm³ or higher, still more preferably 2.65 g/cm³ or higher.

On the other hand, the density of the SiSiC component 1 is preferably 3.50 g/cm³ or lower, more preferably 3.30 g/cm³ or lower, still more preferably 3.10 g/cm³ or lower.

The density of the SiSiC component 1 is measured according to a method described in JIS Z8807-2012.

### <Expansion Coefficient>

The average linear expansion coefficient (hereinafter also simply referred to as “expansion coefficient”) of the SiSiC component 1 at room temperature (23° C.) to 800° C. is preferably 4.0 ppm/° C. or lower, more preferably 3.7 ppm/° C. or lower, still more preferably 3.4 ppm/° C. or lower.

As a method for controlling the expansion coefficient of the SiSiC component 1 to the above range, for example, there may be mentioned a method of controlling the content of elemental Si in the SiSiC component 1 to the range mentioned above.

The expansion coefficient of the SiSiC component 1 is measured according to a method described in JIS R1618 with the use of e.g. a thermal dilatometer (product name: TD5000SA, manufactured by NETZSCH Corporation).

### <Thermal Conductivity>

The thermal conductivity of the SiSiC component 1 is preferably 180 W/(m·K) or higher, more preferably 200 W/(m·K) or higher, still more preferably 220 W/(m·K) or higher.

As a method for controlling the thermal conductivity of the SiSiC component 1 to the above range, for example, there may be mentioned a method of controlling the content of elemental Si in the SiSiC component 1 to the range mentioned above.

The thermal conductivity of the SiSiC component 1 is determined at room temperature (23° C.) by a flash method using a xenon lamp light of LFA 447 (Nanoflash) manufactured by NETZSCH Corporation.

### [Production Method of SiSiC Component]

Next, a production method of the SiSiC component will be explained below.

### <Preparation of SiC Formed Body>

First, a SiC formed body (not shown) containing SiC particles is prepared.

The SiC formed body is a porous body having a plurality of pores. Thus, the SiC formed body is impregnated with molten elemental Si as will be described below.

The porosity of the SiC formed body is preferably 30 to 70 vol %, more preferably 40 to 60 vol %. The porosity is determined using a mercury porosimeter.

The dimensions and shape of the SiC formed body are not particularly limited and are appropriately set according to the dimensions and shape of the finally obtained SiSiC component.

### «3D Printing Method»

For the preparation of the SiC formed body, for example, a 3D (three-dimensional) printing method such as a laser additive manufacturing method or a binder jetting method is used. In the 3D printing method, the SiC formed body is obtained as a laminated body of desired shape by forming and laminating layers sequentially one by one. The thickness of each of the sequentially laminated layers is, for example, 0.2 to 0.3 mm.

In the laser additive manufacturing method, a layer containing SiC particles and a binder is irradiated with a laser light. By heat of the laser light, the binder in the irradiated region is melted and solidified whereby the SiC particles are bound to each other. By performing this operation for each sequentially laminated layer, the SiC formed body is prepared.

In the binder jetting method, a binder is jetted from an ink jet nozzle onto a layer containing SiC particles. In the region where the binder is jetted, the SiC particles are bound to each other. By performing this operation for each sequentially laminated layer, the SiC formed body is prepared.

In the binder jetting method, a curing agent (e.g. an aqueous acidic substance containing xylenesulfonic acid, sulfuric acid or the like) may be added to the layer containing the SiC particles so as to cause reaction (curing) of the binder only in the region where the jetted binder comes into contact with the curing agent. The content of the curing agent is, for example, 0.1 to 1 mass % with respect to the SiC particles.

The SiC particles are preferably of α-SiC.

The average particle size of the SiC particles is, for example, 5 to 300 μm, preferably 30 to 200 μm, more preferably 50 to 180 μm.

In general, as the SiC particles become larger, the SiC formed body obtained therefrom increases in pore size. Accordingly, the average particle size of the SiC particles used can be selected as appropriate according to the desired pore size.

The average particle size of the SiC particles is a 50% volume cumulative size (D50) of the particles as determined by measurement with a laser diffraction/scattering particle size distribution analyzer (MT3300EXII, manufactured by MicrotracBEL Corporation).

Examples of the binder include: thermosetting resins such as phenolic resins; self-curing resins such as furan resins; and the like.

### «Casting Method»

For the preparation of the SiC formed body, the 3D printing method is not necessarily used.

The SiC formed body may be prepared by, for example, pouring a mixture of SiC particles and a binder (a SiC formed body raw material) into a mold and drying the mixture (for convenience called a “casting method”).

In the casting method, the solid content of the SiC formed body raw material can be varied as appropriate within the range of 5 to 100 mass %. After the drying, the SiC formed body may be sintered by heating at high temperature (e.g. 1500 to 2300° C.) in an inert atmosphere.

As such a casting method, there may be mentioned a drain casting method, an isostatic pressing method, an extrusion method and the like. Specific examples of the casting method are those described in JP-H5-32458.

As the method for preparing the SiC formed body, preferred is the 3D printing method.

The 3D printing method is easier to control the porosity of the SiC formed body. There is thus obtained the SiSiC component in which the amount of elemental Si introduced by the after-mentioned Si impregnation is arbitrarily controlled. By controlling the amount of elemental Si, it is possible to reduce the axis deviation amount caused during the process of forming the long hole by electrical discharge machining and to improve the fouling resistance.

### <C Impregnation and Drying>

Optionally, the SiC formed body may be impregnated with a dispersion liquid of carbon particles (a carbon dispersion liquid). This is hereinafter called “C impregnation”.

By this, the carbon particles are introduced into the pores of the porous SiC formed body.

In such a case, when the SiC formed body is impregnated with Si as will be described below, a part of Si is converted to silicon carbide (SiC) by reaction with the carbon particles (C).

For ease of introduction of the carbon particles, it is preferable to perform the C impregnation in a reduced-pressure environment. It is preferable to afterwards switch from the reduced-pressure environment to a pressurized environment. This makes it easier to introduce the carbon particles.

The content of the carbon particles in the carbon dispersion liquid is, for example, 20 to 60 mass %, preferably 30 to 55 mass %.

The average particle size (D50) of aggregated particles (secondary particles) of the carbon particles is, for example, 100 to 200 nm, preferably 110 to 150 nm.

Examples of the dispersion medium of the carbon dispersion liquid include: water; alcohols such as methanol and ethanol; and the like.

It is preferable to perform drying after the C impregnation. By this, the dispersion medium of the carbon dispersion liquid is removed.

As the drying method, there can be used air drying, heat drying, vacuum freeze drying or the like.

In the heat drying, the dispersion medium is volatized and removed. In the case where the dispersion medium is water, the heating temperature is, for example, 100 to 120° C.

In the vacuum freeze drying, the dispersion medium is frozen by cooling in a drying chamber. The cooling temperature is a temperature lower than a freezing temperature of the dispersion medium. In the case where the dispersion medium contains water, the cooling temperature is, for example, −50 to −5° C. After the freezing, the dispersion medium is sublimated and removed by evacuating the inside of the drying chamber.

### <Si Impregnation>

Then, the SiC formed body is impregnated with silicon (Si). This is hereinafter called “Si impregnation”.

More specifically, in a state that the SiC formed body and elemental Si are held in contact with each other, the elemental Si is melted by heating these materials (the SiC formed body and elemental Si). By this, the porous SiC formed body is impregnated with the molten elemental Si under the capillary action.

There is thus obtained the SiSiC component as the composite material in which the SiC formed body is impregnated with the elemental Si.

When elemental Si is melted in a state of being placed on an upper surface of the SiC formed body, it is easier to impregnate the SiC formed body with the molten elemental Si under the action of gravity.

The environment for melting elemental Si is preferably a reduced-pressure environment.

It is acceptable that the heating temperature is higher than or equal to a melting point of Si. The melting point of Si slightly varies depending on the measurement method, but is approximately 1410 to 1414° C. The heating temperature is preferably 1500° C. or higher.

On the other hand, the heating temperature is preferably, for example, 2300° C. or lower, more preferably 2000° C. or lower, still more preferably 1650° C. or lower.

The amount of Si introduced into the SiC formed body is appropriately set according to the content of elemental Si in the finally obtained SiSiC component.

The obtained SiSiC component is sintered by the heating for melting elemental Si.

In other words, the dense sintered component is obtained by bonding between SiC and by bonding between SiC and Si.

Accordingly, the thus-obtained SiSiC component is a composite material containing Si and SiC and is a sintered product.

### <Electrical Discharge Machining>

The SiSiC component obtained by the Si impregnation is subjected to electrical discharge machining whereby the above-mentioned long hole is formed.

The electrical discharge machining is a technique of, by generating arc discharge between an electrode (copper, graphite or the like) and a workpiece (in this case, the SiSiC component) in a working bath filled with a working fluid (water or oil), machining the workpiece while dissolving the workpiece at high temperature (e.g. 3000° C. or higher).

The workpiece is machined by repeatedly generating discharge a few thousand to a million times per second in a state that the electrode and the workpiece are kept from contact with each other with a distance of about several tens of μm maintained therebetween.

Since the workpiece is always cooled by the water or oil, only a part of the workpiece directly below the electrode is locally dissolved and machined.

By the way, the workpiece used in the electrical discharge machining is required to have electrical conductivity (allow conduction of electricity) in order to generate arc discharge between the workpiece and the electrode.

For example, a simple SiC formed body does not have electrical conductivity, and thus cannot undergo electrical discharge machining without the generation of arc discharge between the SiC formed body and the electrode.

By contrast, the SiSiC component obtained by the Si impregnation has electrical conductivity by adequately containing elemental Si, and thus undergoes electrical discharge machining with the generation of arc discharge between the SiSiC component and the electrode.

In this way, the SiSiC component obtained by the Si impregnation is formed with the above-mentioned long hole by the electrical discharge machining.

When the long hole is formed by the electrical discharge machining, it is possible to suppress the occurrence of a burr or the adhesion of a deposit on a surface of the SiSiC component (for example, a surface of the inner wall of the long hole).

Further, the long hole of the SiSiC component may be clogged due to the adhesion of a deposit containing: Si eluted from the body of the SiSiC component; a compound containing C derived from a resin and the like adhered to the inner wall of the long hole; an impurity included in the SiSiC component; or the like, onto the surface of the inner wall of the long hole.

Si eluted from the SiSiC component is derived from elemental Si used in the Si impregnation.

A Si spout caused in a long hole which is formed using a pipe (carbon tube or SiC tube) as described in Patent Documents 2 and 3 is also a kind of such Si eluate.

A constituent element of the impurity can be, for example, at least one kind selected from the group consisting of Al, Ba, Ca, Cd, Co, Cr, Cu, Fe, K, Li, Mg, Mn, Mo, Na, Nb, Ni, P, Pb, Sb, Sn, Sr, Ti, V, Zn and Zr.

Moreover, there is a case that a new long hole is formed in the SiSiC component so as to connect a plurality of long holes. In this case, if the new long hole is formed by mechanical machining (e.g. machining with a drill) or the like, a burr may occur on the surface of the inner wall of the long hole at an intersection between the long holes.

In the above-mentioned cases, the deposit and/or the burr can be removed by performing the electrical discharge machining. The conditions of such electrical discharge machining are not particularly limited and may be the same as those for the formation of the long hole.

As the facilities for the electrical discharge machining (including the electrode, the working bath and the like), there can be used conventionally known facilities without particular limitations.

The conditions of the electrical discharge machining are appropriately adjusted and set in such a manner that the above-mentioned long hole can be formed in the SiSiC component.

### [Uses of SiSiC Component]

The uses of the SiSiC component with the long hole are not particularly limited. The SiSiC component are usable as heating equipment because of its excellent properties such as strength (Young's modulus) and thermal conductive property (thermal conductivity). For example, the SiSiC component is suitable for use as a top plate of a heating cooker such as an IH (induction heating) cooker.

The top plate of the heating cooker is a member on which an object to be heated, such as a pot, is placed.

Conventionally, ceramics and the like are used as a material of the top plate. The top plate is required to be capable of rapid temperature rise and fall and to have high impact resistance. The SiSiC component is therefore suitably usable as the top plate of the heating cooker.

For temperature control, a thermocouple (not shown) is inserted in the long hole of the SiSiC component. With this, the temperature of the SiSiC component and, by extension, the temperature of the object to be heated on the SiSiC component can be grasped.

The heating cooler may be used as a part of a system kitchen.

The system kitchen includes devices such as a worktable and a heating cooker. These devices are connected by a worktop. As a material of the worktop, stainless steel, artificial marble, ceramics and the like are used.

The heating cooker is used, for example, by being incorporated into an opening provided in the work top. In this case, the top plate of the heating cooker may constitute a part of the worktop of the system kitchen.

### EXAMPLES

The present invention will be now described in further detail with reference to Examples. It should however be understood that the present invention is not limited to Examples described below.

Herein, Ex. 1 to 6 are Working Examples; and Ex. 7 to 9 are Comparative Examples.

### Ex. 1

A SiC formed body was prepared by a 3D printing method (indicated as “3DP” in the following Table 1).

In other words, the SiC formed body was prepared by a binder jetting method using a powder deposition type 3D printer.

More specifically, a layer (thickness: about 0.2 mm) was formed from a mixture of SiC particles and a curing agent; and a binder was jetted from an ink jet nozzle onto the formed layer. By repeating this operation, the SiC formed body of rectangular parallelepiped shape (300 mm length×300 mm width×20 mm thickness) was prepared.

As the SiC particles, an α-SiC powder (average particle size: 80 μm, manufactured by Shinano Electric Refining Co., Ltd.) was used. As the curing agent, a commercially available product (an aqueous acidic substance containing xylenesulfonic acid and sulfuric acid) manufactured by ASK Chemicals Japan Co., Ltd. was used. The content of the curing agent in the mixture was 0.3 mass % with respect to the SiC particles. As the binder, a furan resin (manufactured by ASK Chemicals Japan Co., Ltd.) was used.

Next, C impregnation was performed. More specifically, the SiC formed body was immersed in a carbon dispersion liquid in which carbon particles (average particle size of secondary particles: 120 nm) was dispersed in water in a reduced-pressure environment. The content of the carbon particles in the dispersion liquid was appropriately adjusted in such a manner as to attain the content of elemental Si as shown in the following Table 1 during the after-mentioned Si impregnation. The SiC formed body was thus impregnated with the carbon dispersion liquid.

After that, drying (vacuum freeze drying) was performed. More specifically, the SiC formed body after the impregnation with the carbon dispersion liquid was cooled in a drying chamber at a temperature of −10 to 0° C. for 20 minutes; and then, the inside of the drying chamber was evacuated.

Subsequently, Si impregnation was performed. More specifically, elemental Si was placed on the SiC formed body in a reaction furnace. The amount of elemental Si placed was adjusted in such a manner as to attain the content (unit: vol %) of elemental Si in the obtained SiSiC component as shown in the following Table 1 (the same applies to the following). After that, the inside of the reaction furnace was heated to 1550° C. in a state of being controlled to a reduced-pressure environment. As a result, elemental Si was melted; and the SiC formed body was impregnated with the molten elemental Si.

There was thus obtained a SiSiC component as a sintered product containing elemental Si and SiC.

The obtained SiSiC component was subjected to electrical discharge machining (working fluid: pure water, electrode: copper) with the use of a commercially available electrical discharge machine (a small hole electric discharge machine CT500FX manufactured by ELENIX Co., Ltd.), whereby three long holes of different diameters (hole shape: perfect circle shape, length: 100 mm) were formed so as not to overlap one another. To be more specific, a long hole of 2 mm diameter, a long hole of 0.8 m diameter and a long hole of 0.1 mm diameter were formed.

In this way, obtained was the SiSiC component in which the long holes were formed.

### Ex. 2

A SiC formed body was prepared by a casting method (indicated as “Casting” in the following Table 1).

More specifically, pure water and a water-soluble phenolic resin were added to and mixed with α-SiC particles classified by a 325-mesh sieve and having a maximum particle size of 44 μm and an average particle size of 8 μm, thereby obtaining a SiC formed body material raw material (solid content: 76 mass %).

By the method (drain casting method) in which: the SiC formed body raw material was poured in and applied to a plaster mold; and then the remaining SiC formed body raw material (slurry) was discharged out, the SiC formed body of rectangular parallelepiped shape (300 mm length×300 mm width×20 mm thickness) was prepared.

A SiSiC component was produced from the prepared SiC formed body, followed by forming therein long holes, in the same manner as in Ex. 1 except that the content (unit: vol %) of elemental Si was changed.

### Ex. 3 to 6

A SiSiC component was produced, followed by forming therein long holes, in the same manner as in Ex. 1 except that the content (unit: vol %) of elemental Si was changed.

### Ex. 7

A SiC formed body was prepared in the same manner as in Ex. 1 and used as a SiC component in which the content of elemental Si was 0 vol %.

Although it was attempted to form long holes in this SiC component by electrical discharge machining, the formation of long holes by electrical discharge machining did not proceed due to the generation of no arc discharge.

### Ex. 8

A SiSiC component was produced in the same manner as in Ex. 1 except that the content of elemental Si was changed to 5 vol %.

Although it was attempted to form long holes in this SiSiC component by electrical discharge machining, the formation of long holes by electrical discharge machining also did not proceed due to the generation of no arc discharge.

### Ex. 9

A SiSiC component was produced, followed by forming therein long holes, in the same manner as in Ex. 1 except that the content of elemental Si was changed to 70 vol %.

As explained above, the samples of Ex. 1 to 9 (Ex. 1 to 6 and 9: the SiSiC component with the long holes, Ex. 7: the SiC component with no long holes, Ex. 8: the SiSiC component with no long holes) were obtained.

### <Various Physical Properties>

The samples of Ex. 1 to 9 were evaluated for the content of elemental Si, the density, the expansion coefficient, the Young's modulus, the thermal conductivity and the electrical resistivity according to the above-mentioned methods.

Furthermore, the long holes formed in the samples of Ex. 1 to 6 and 9 were evaluated for the axis deviation amount, the surface roughness of the inner wall and the O content in the inner wall according to the above-mentioned methods. The evaluations of the surface roughness and the O content were made on the long holes of 2 mm diameter.

As to the samples of Ex. 7 and 8 in which no long holes were formed, these properties were not evaluated and were indicated as “-” in the following Table 1.

### <Adhesion to Inner Wall of Long Hole>

The adhesion to the inner wall of the long hole was evaluated by the following method.

The SiSiC component was cut into a size of 100 mm length×10 mm width×10 mm thickness in such a manner that the inner wall of the long hole was exposed. A single-sided tape of 0.17 mm thickness and 3 mm×200 mm size (acrylic waterproof tape #7300 manufactured by Sekisui Chemical Co., Ltd.) was adhered to the exposed surface including the inner wall of the cut SiSiC component, thereby obtaining a laminate.

To the obtained laminate, a load of 9.8 N was applied at room temperature for 5 minutes with the use of Instron 5560 manufactured by INSTRON Corporation. After that, the amount of displacement between the SiSiC component and the tape was measured with an optical microscope. The adhesion to the inner wall of the long hole was evaluated to be higher due to higher shear holding power as the measured displacement amount was smaller.

In the following Table 1, the evaluation result was indicated as “©” when the displacement amount was larger than or equal to 0 mm and smaller than 0.5 mm; “O” when the displacement amount was larger than or equal to 0.5 mm and smaller than 1.5 mm; and “x” when the displacement amount was larger than 1.5 mm.

### <Fouling Resistance of Inner Wall of Long Hole>

The fouling resistance of the inner wall of the long hole was evaluated by the following method.

The SiSiC component was cut into a size of 100 mm length×10 mm width×10 mm thickness in such a manner that the inner wall of the long hole was exposed. Onto the exposed surface including the inner wall of the cut SiSiC component, 3 g of dust particles (KANTO-Loam JIS Test Powder Class 11) were blown.

After that, the surface of the inner wall of the long hole was observed at a magnification of 100 times with the use of a digital microscope VHX-5000 manufactured by KEYENCE Corporation. By image processing of the observed micrograph, the rate of the area where the fine particles were adhered was determined. The fouling resistance was evaluated to be higher as the determined rate was lower.

In the following Table 1, the evaluation result was indicated as: “⊚” when the rate of the area of adhesion of the fine particles was lower than 5%; “◯” when the rate of the area of adhesion of the fine particles was higher than or equal to 5% and lower than 10%; and “x” when the rate of the area of adhesion of the fine particles was higher than or equal to 10%.

TABLE 1

| | | | Ex. 1 | Ex. 2 | Ex. 3 | Ex. 4 | Ex. 5 |
|---|---|---|---|---|---|---|---|
| Preparation method of SiC formed | | — | 3DP | Casting | 3DP | 3DP | 3DP |
| body | | | | | | | |
| Content of elemental Si | | vol % | 11 | 18 | 25 | 27 | 32 |
| Density | | g/cm³ | 3.10 | 3.10 | 3.00 | 2.96 | 2.85 |
| Expansion coefficient | | ppm/° C. | 3.4 | 3.4 | 3.3 | 3.3 | 3.2 |
| Young's modulus | | GPa | 390 | 370 | 356 | 341 | 293 |
| Thermal conductivity | | W/(m · k) | 223 | 220 | 230 | 223 | 202 |
| Electrical resistivity | | Ω · cm | 2.94 × 10⁻¹ | 4.23 × 10⁻¹ | 7.17 × 10⁻² | 1.04 × 10⁻¹ | 1.64 × 10⁻² |
| Long | Axis deviation amount | mm | 0.13 | 0.31 | 0.12 | 0.08 | 0.07 |
| hole | (Diameter: 2 mm) | | | | | | |
| | Axis deviation amount | mm | 0.48 | 0.62 | 0.29 | 0.21 | 0.16 |
| | (Diameter: 0.8 mm) | | | | | | |
| | Axis deviation amount | mm | 0.92 | 0.89 | 0.83 | 0.74 | 0.62 |
| | (Diameter: 0.1 mm) | | | | | | |
| | Surface roughness of inner wall | μm | 4.1 | 3.2 | 5.2 | 7.5 | 6.9 |
| | O content in inner wall | atomic % | 5 | 3 | 10 | 13 | 15 |
| | Adhesion to inner wall | — | ◯ | ◯ | ⊚ | ⊚ | ⊚ |
| | Fouling resistance of inner wall | — | ◯ | ◯ | ⊚ | ⊚ | ⊚ |

| | | | Ex. 6 | Ex. 7 | Ex. 8 | Ex. 9 |
|---|---|---|---|---|---|---|
| Preparation method of SiC formed | | — | 3DP | 3DP | 3DP | 3DP |
| body | | | | | | |
| Content of elemental Si | | vol % | 58 | 0 | 5 | 70 |
| Density | | g/cm³ | 2.70 | 2.75 | 3.15 | 2.60 |
| Expansion coefficient | | ppm/° C. | 3.2 | 4.5 | 3.3 | 3.4 |
| Young's modulus | | GPa | 249 | 354 | 400 | 211 |
| Thermal conductivity | | W/(m · k) | 182 | 170 | 218 | 165 |
| Electrical resistivity | | Ω · cm | 2.13 × 10⁻³ | 5.32 × 10⁵ | 3.21 × 10² | 3.17 × 10⁻² |
| Long | Axis deviation amount | mm | 0.05 | — | — | 0.06 |
| hole | (Diameter: 2 mm) | | | | | |
| | Axis deviation amount | mm | 0.11 | — | — | 0.13 |
| | (Diameter: 0.8 mm) | | | | | |
| | Axis deviation amount | mm | 0.67 | — | — | 0.63 |
| | (Diameter: 0.1 mm) | | | | | |
| | Surface roughness of inner wall | μm | 5.7 | — | — | 5.1 |
| | O content in inner wall | atomic % | 19 | — | — | 16 |
| | Adhesion to inner wall | — | ⊚ | — | — | ⊚ |
| | Fouling resistance of inner wall | — | ⊚ | — | — | ⊚ |

### <Conclusion of Evaluation Results>

As shown in Table 1 above, in Ex. 1 to 6, the long holes were formed in the SiSiC components by electrical discharge machining; and the SiSiC components had good physical properties such as Young's modulus.

In Ex. 7 and 8, by contrast, the long holes were not formed by electrical discharge machining.

In Ex. 9, the SiSiC component was low in Young's modulus.

This application is a continuation of PCT Application No. PCT/JP2023/005423, filed on Feb. 16, 2023, which is based upon and claims the benefit of priority from Japanese Patent Application No. 2022-024100 filed on Feb. 18, 2022 and Japanese Patent Application No. 2022-162968 filed on Oct. 11, 2022. The contents of those applications are incorporated herein by reference in their entireties.

### REFERENCE SYMBOLS

1: SiSiC component
2: Long hole
3: Inner Wall

What is claimed is:

1. A SiSiC component having at least one long hole formed therein,
wherein the long hole has a diameter of 2 mm or smaller,
wherein the long hole has a length of 100 mm or longer, and
wherein the content of elemental Si in the SiSiC component is 10 to 60 vol %.

2. The SiSiC component according to claim 1, which has a Young's modulus of 230 GPa or higher.

3. The SiSiC component according to claim 1, which has an electrical resistivity of 0.0001 to 100 Ω·cm.

4. The SiSiC component according to claim 1, wherein the long hole is a non-through hole.

5. The SiSiC component according to claim 1, wherein an inner wall of the long hole has a surface roughness of 3.0 μm or greater.

6. The SiSiC component according to claim 1, wherein an axis deviation amount of the long hole is 0.80 mm or less.

7. The SiSiC component according to claim 1, wherein the hole shape of the long hole is a circular shape, a polygonal shape, or a combined shape thereof.

8. The SiSiC component according to claim 1, wherein the O content in an inner wall of the long hole is 1 atomic % or higher.

9. A method of producing the SiSiC component as defined in claim 1, comprising:
preparing a SiC formed body;
impregnating the SiC formed body with elemental Si; and
forming a long hole in the obtained SiSiC component by electrical discharge machining.

10. A method of producing a SiSiC component, comprising:
preparing a SiC formed body;
impregnating the SiC formed body with elemental Si; and
performing electrical discharge machining on the obtained SiSiC component.

11. The method of producing a SiSiC component according to claim 10, wherein occurrence of a burr on a surface of the SiSiC component is suppressed.

12. The method of producing a SiSiC component according to claim 10, wherein adhesion of a deposit to a surface of the SiSiC component is suppressed.

13. The method of producing a SiSiC component according to claim 10, comprising:
preparing the SiC formed body;
impregnating the SiC formed body with the elemental Si; and
performing the electrical discharge machining on the obtained SiSiC component, whereby a deposit adhered to a surface of the SiSiC component is removed.

14. The method of producing a SiSiC component according to claim 13, wherein the deposit contains Si eluted from the SiSiC component.

15. The method of producing a SiSiC component according to claim 10, comprising:
preparing the SiC formed body;
impregnating the SiC formed body with the elemental Si; and
performing the electrical discharge machining on the obtained SiSiC component, whereby a burr occurring on a surface of the SiSiC component is removed.
